(19) United States
(12) Patent Application Publication
(10) Pub. No.: US 2025/0360650 A1
(43) Pub. Date: Nov. 27, 2025

(54) CHEMICAL GRAFTING AGENT FOR BINDER JETTING OF STRONG GREEN PARTS AND METHOD FOR APPLYING THE SAME

(71) Applicant: Chao MA, Gilbert, AZ (US)

(72) Inventor: Chao MA, Gilbert, AZ (US)

(73) Assignee: Arizona Board of Regents on Behalf of Arizona State University, Scottsdale, AZ (US)

(21) Appl. No.: 19/219,926

(22) Filed: May 27, 2025

Related U.S. Application Data
(60) Provisional application No. 63/651,858, filed on May 24, 2024.

(51) Int. Cl. B28B 1/00; B33Y 10/00; B33Y 40/20; B33Y 70/00

(52) U.S. Cl. CPC B28B 1/001; B33Y 70/00; B33Y 10/00; B33Y 40/20

(57) ABSTRACT

A method of binder jetting strong green parts using a chemical grafting agent is disclosed. The method includes preparing a binder and a powder for binder jetting. The binder may comprise a first sorbent and the powder may comprise a second sorbent. The chemical grafting agent is introduced to enable covalent bonding between the binder and the powder. The grafting agent may be premixed with the binder, premixed with the powder, and/or delivered in situ during printing via a printhead. The binder is selectively jetted into layers of powder to form a green part, which is then cured to complete the grafting reactions and strengthen the part without sintering. The resulting green parts exhibit improved mechanical integrity and can be fabricated from heat-sensitive materials.

### RELATED APPLICATIONS

This application claims the benefit of U.S. provisional patent application 63/651,858, filed May 24, 2024 to Chao Ma, titled “CHEMICAL GRAFTING AGENT FOR BINDER JETTING OF STRONG GREEN PARTS AND METHOD FOR APPLYING THE SAME,” the entirety of the disclosure of which is hereby incorporated by this reference.

### TECHNICAL FIELD

This document relates to a method for fabricating a green part through binder jet fabrication with a chemical grafting agent.

### BACKGROUND

Binder jetting is an additive manufacturing process with many advantages. It can be used with almost any material, such as ceramics, metals, and polymers. It can produce parts in a wide range of sizes, up to multiple meters. It can also produce parts with almost any geometry. For example, explicit support is not required for overhang structures. Furthermore, the energy consumption, operational cost, and capital cost of binder jetting are low.

A “green part” refers to the state of a part after the initial shaping process but before sintering. A challenging issue in binder jetting is that green parts are usually too weak to directly serve in many applications. Sintering is often performed to strengthen the green parts. However, sintering is not an option with materials that are sensitive to high temperatures, such as sorbents for gas separation (e.g., carbon capture sorbents, etc.).

### SUMMARY

According to some embodiments, a method for fabricating a green part through binder jet fabrication comprises preparing a binder comprising a first sorbent and a powder comprising a second sorbent for the binder jet fabrication, printing the green part layer by layer by cyclically spreading a layer of powder and selectively jetting the binder through a printhead into the layer of powder, curing a job box containing loose powder and the green part comprising the binder, the powder, and a chemical grafting agent, and depowdering the green part by removing the green part from the loose powder.

Particular embodiments may comprise one or more of the following features. The binder may comprise polyethylenimine, the powder may comprise Zeolite 13X, and the chemical grafting agent may comprise 3-triethoxysilylpropyl isocyanate. Preparing the binder and the powder may comprise mixing the chemical grafting agent with at least one of the binder and the powder. Preparing the binder may further comprise adding a NaOH solution to the binder and chemical grafting agent. Printing the green part may further comprise introducing the chemical grafting agent to the green part in-situ, through the printhead. The powder may comprise surface hydroxyl groups.

According to some embodiments, a method for fabricating a green part through binder jet fabrication comprises preparing a binder and a powder for the binder jet fabrication, printing the green part layer by layer by cyclically spreading a layer of powder and selectively jetting the binder through a printhead into the layer of powder, curing a job box containing loose powder and the green part comprising the binder, the powder, and a chemical grafting agent, and depowdering the green part by removing the green part from the loose powder.

Particular embodiments may comprise one or more of the following features. Preparing the binder may comprise mixing the chemical grafting agent with the binder. Preparing the binder may further comprise adding a NaOH solution to the binder and chemical grafting agent. The binder may comprise polyethylenimine and the powder may comprise Zeolite 13X. The chemical grafting agent may comprise 3-triethoxysilylpropyl isocyanate. Printing the green part may further comprise introducing the chemical grafting agent to the green part in-situ, through the printhead. Preparing the powder may comprise mixing the chemical grafting agent with the powder. The powder may comprise surface hydroxyl groups.

According to some embodiments, a method for fabricating a green part through binder jet fabrication comprises preparing a binder comprising a first sorbent and a powder comprising a second sorbent for the binder jet fabrication, printing the green part layer by layer by cyclically spreading a layer of powder and selectively jetting the binder through a printhead into the layer of powder, curing a job box containing loose powder and the green part comprising the binder and the powder, and depowdering the green part by removing the green part from the loose powder.

Particular embodiments may comprise one or more of the following features. Preparing the binder may comprise mixing the chemical grafting agent with the binder. The binder may comprise polyethylenimine, the powder may comprise Zeolite 13X, and the chemical grafting agent may comprise 3-triethoxysilylpropyl isocyanate. Preparing the binder may further comprise adding a NaOH solution to the binder and chemical grafting agent. Preparing the powder may comprise mixing a chemical grafting agent with the powder. The powder may comprise surface hydroxyl groups.

According to some embodiments, a composition may comprise a binder comprising a first sorbent, a powder comprising a second sorbent, and a chemical grafting agent comprising a silane moiety, wherein the chemical grafting agent forms covalent bonds between the binder and the powder.

Particular embodiments may comprise one or more of the following features. The chemical grafting agent may comprise 3-triethoxysilylpropyl isocyanate. The powder may further comprise surface hydroxyl groups selected from the group consisting of zeolites, metal oxides, and ceramic particles. The covalent bonds may comprise urethane and urea linkages formed between the binder and the powder. The binder may comprise a polyamine or a compound having multiple amine functional groups. The composition may be formed without thermal sintering above 150° C.

The foregoing and other aspects, features, and advantages will be apparent from the DESCRIPTION and DRAWINGS, and from the CLAIMS if any are included.

### BRIEF DESCRIPTION OF THE DRAWINGS

Implementations will hereinafter be described in conjunction with the appended and/or included DRAWINGS, where like designations denote like elements.

FIG. 1 is a schematic illustrating a method of fabricating strong green parts using binder jetting, where a chemical grafting agent is pre-mixed into the binder prior to printing according to some embodiments.

FIG. 2 is a schematic illustrating a method of fabricating strong green parts using binder jetting, where a chemical grafting agent is pre-mixed into the powder prior to printing according to some embodiments.

FIG. 3 is a schematic illustrating a method of fabricating strong green parts using binder jetting, where a chemical grafting agent is delivered in situ via the printhead during the printing process according to some embodiments.

FIGS. 4A and 4B provide a comparative diagram showing the difference in bonding between conventional processes and the presently disclosed method, with FIG. 4A showing hydrogen bonds between binder and powder in conventional processes and FIG. 4B showing the covalent bonds formed using the grafting agent.

### DETAILED DESCRIPTION

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

Throughout the description and claims of this specification, the words “comprise” and “contain” and variations of the words, for example “comprising” and “comprises”, mean “including but not limited to”, and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

Contemplated herein is a chemical grafting agent for binder jetting of strong green parts, and method for using the same. Chemical grafting agents are compounds designed to modify the surface or bulk properties of materials by covalently bonding functional molecules, polymers, or other chemical species to a substrate. These agents typically contain reactive functional groups, such as epoxy, isocyanate, or silane moieties, which facilitate the formation of strong, durable chemical bonds with the target material. The grafting process enables precise tailoring of properties such as adhesion, biocompatibility, chemical resistance, or hydrophobicity.

In some embodiments, the presently disclosed chemical grafting agent will allow binder jetting to produce strong green parts directly, without requiring high-temperature thermal processing such as sintering. This capability opens up a new class of materials and applications that were not feasible with conventional binder jetting methods, such as allowing for binder jetting with heat-sensitive materials that cannot survive high-temperature thermal processing. According to various embodiments, the chemical grafting agent facilitates the formation of covalent bonds between the binder and the powder that improve the strength of the green part without requiring high-temperature thermal processing. According to various embodiments, strong green parts can be used as sorbents for gas separation (such as carbon capture sorbent materials) and water treatment, catalysts, tooling, and the like.

Like conventional binder jetting itself, the chemical agents and methods contemplated herein open up a staggering number of new applications for this manufacturing technology. One particular application is the manufacturing of objects out of material that can absorb carbon dioxide, for the purpose of carbon capture.

Based on the U.N. IPCC's latest comprehensive assessment, the deployment of CO2 removal technologies will be necessary to achieve net zero emissions. According to U.N. IPCC's prediction, at least 2 gigatonnes of CO2 must be removed from the atmosphere by 2030. The U.S. government is providing a financial incentive of $130-180 per tonne of CO2 removed through direct air capture (i.e., directly capturing CO₂ from the atmosphere). With these values, the market is estimated to be on the scale of ˜$100 billion. Furthermore, the amount of CO2 needing to be removed will significantly increase in the coming decades, meaning this huge market will continue to expand.

The chemical agents and methods contemplated herein hold the potential to significantly improve the performance of these direct air capture products. The economics driving the use of direct air capture leave the devices a very thin energy budget to operate within. The ability to shape sorbent materials into almost any geometry that is enabled through the presently disclosed methods will make it possible to maximize exposure at minimal energy cost. In some cases, these shapes may also accelerate the release of the captured carbon dioxide through exposure to a release medium (e.g., water, steam, heat, electricity, etc.), depending upon the sorbent material.

Of course, sorbent materials are one of many categories of temperature-sensitive materials that can be used with chemical grafting agents to create strong green parts. The improved binder jetting process holds the potential to significantly expand the application space of this already versatile technology.

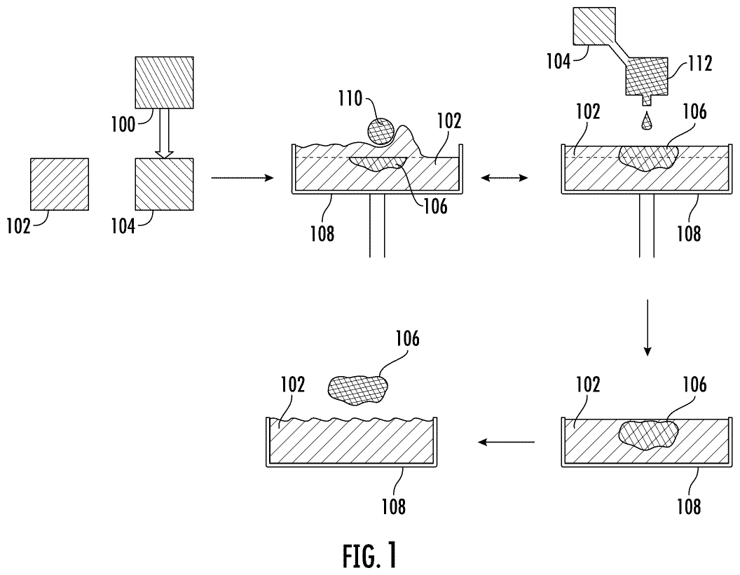

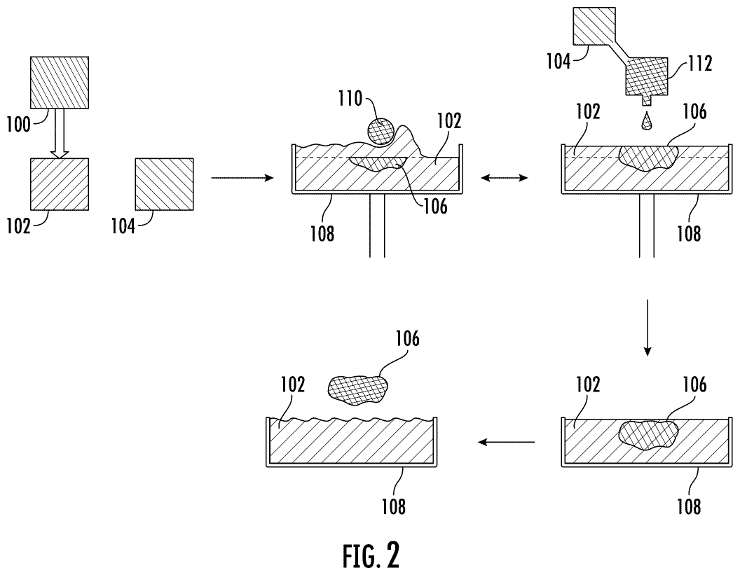

The binder jetting process incorporating a chemical grafting agent 100 may generally be divided into four major stages: (1) material preparation; (2) printing; (3) curing; and (4) depowdering. First, the powder 102 and the binder 104 are prepared. These raw materials are chosen and prepared to have favorable characteristics for the downstream processes and applications. In some embodiments, as part of preparing the binder 104 and the powder 102, the chemical grafting agent 100 is premixed with the binder 104 or powder 102. As illustrated in FIG. 1, in some embodiments, the grafting agent 100 is premixed with the binder 104. As illustrated in FIG. 2, in some embodiments, the grafting agent 100 is premixed with the powder 102. A person of skill in the art will understand that, in some embodiments, the grafting agent 100 may be premixed with both the binder 104 and with the powder 102. While the following discussion is done in the context of an embodiment where the chemical grafting agent 100 is mixed with the binder 104, it should be noted that in other embodiments the agent 100 may be mixed with the powder 102, mixed with both the binder 104 and the powder 102, or may be applied in-situ through a printhead.

In a specific, non-limiting example, the binder 104 is polyethylenimine (PEI), the powder 102 is Zeolite 13X, and the chemical grafting agent 100 is 3-triethoxysilylpropyl isocyanate (TPI). The binder 104 may be prepared by adding TPI to a mixture of PEI and methanol, and the resulting solution may be stirred for a period of time, such as for 2 hours. A NaOH solution may then be added, serving as the catalyst for the chemical grafting reaction later. The molar ratio of TPI to PEI can be changed from 0.5, 1, 2, 5, and 10, according to various embodiments. The Zeolite 13X powder 102 may then be dried in an oven at 150° C. under vacuum for 3 hours before being used for binder jetting.

It should be noted that the use of a first sorbent (e.g., PEI herein) as a binder 104 and a second sorbent (e.g., zeolite herein) as a powder 102 is a novel combination in binder jetting, even without applying the contemplated method for strengthening green parts. Conventional efforts to shape carbon dioxide sorbents using binder jetting techniques have been limited to compositions where the binder does not sorb CO2. The use of a sorbent as a binder 104 is advantageous because it will sorb carbon dioxide, as does the powder 102. Accordingly, novel sorbent structures may be fabricated through binder jetting by using a first sorbent as the binder 104 and a second sorbent as the powder 102. Some of these printed structures (i.e., green parts 106) may be further strengthened using the methods and chemical grafting agents 100 contemplated herein.

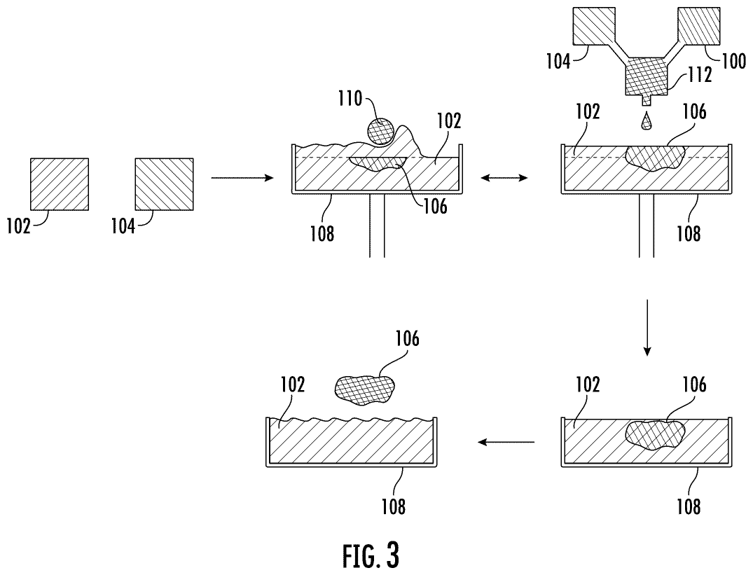

Next is the printing of the green part 106. According to various embodiments, printing can be done with any binder jetting machine, using the binder 104 and powder 102 described above. The process starts with spreading a uniform layer of powder 102. This may be done by adding powder 102 to the job box 108 and moving a recoater roller or recoater blade 110 across the job box 108 to level the powder 102. The binder 104 is then selectively jetted through a printhead 112 according to the cross-sectional shape of the desired parts. These procedures are repeated cyclically, layer by layer, until the entire parts are built. In some embodiments, the chemical grafting agent 100 is introduced in-situ during printing, through a printhead 112, as illustrated in FIG. 3. In embodiments where the chemical grafting agent 100 is delivered in situ, the printhead 112 may comprise a separate reservoir and/or nozzle to dispense the agent 100 simultaneously with the binder 104. This allows spatial and temporal control over the initiation of covalent bonding during fabrication, as shown in FIG. 3.

After the printing comes the curing that strengthens the green parts 106. According to various embodiments, the curing step is performed by placing the entire job box 108 containing the printed parts 106 and the loose powder 102 in a vacuum oven for curing. In some embodiments, the curing is performed in an oven at 80° C. under vacuum for 8 hours to evaporate any solvents. These green parts 106 have now been strengthened by covalent bonds formed between the binder 104 and the powder 102 due to the chemical grafting agent 100.

In embodiments in which the NaOH solution is added, the NaOH facilitates hydrolysis and subsequent crosslinking reactions involving isocyanate and amine or hydroxyl functional groups, thus catalyzing bond formation between the binder 104 and the powder 102. The isocyanate group of TPI reacts with amine groups in PEI to form urea linkages and with hydroxyl groups on the zeolite surface to form urethane linkages. This dual reactivity enables chemical crosslinking between binder 104 and powder 102, improving mechanical performance of the green parts 106.

The final step, according to various embodiments, is depowdering, where the green parts 106 are retrieved from the surrounding loose powder 102.

In this specific, non-limiting example, the binder 104 was PEI (a polyamine), the powder 102 was Zeolite 13X, and the chemical grafting agent 100 was TPI catalyzed by NaOH. According to various embodiments, TPI catalyzed by NaOH will work with other binders 104 including, but not limited to, other polyamines and other compounds containing amine functional groups. In some embodiments, the powder 102 may be powdered materials having surface hydroxyl groups including, but not limited to, ceramic powders and metallic powders. For example, silica-based ceramics and metal oxides inherently possess surface hydroxyl groups. These groups serve as reactive sites for silane-based grafting agents, facilitating the formation of robust covalent bonds with the binder matrix.

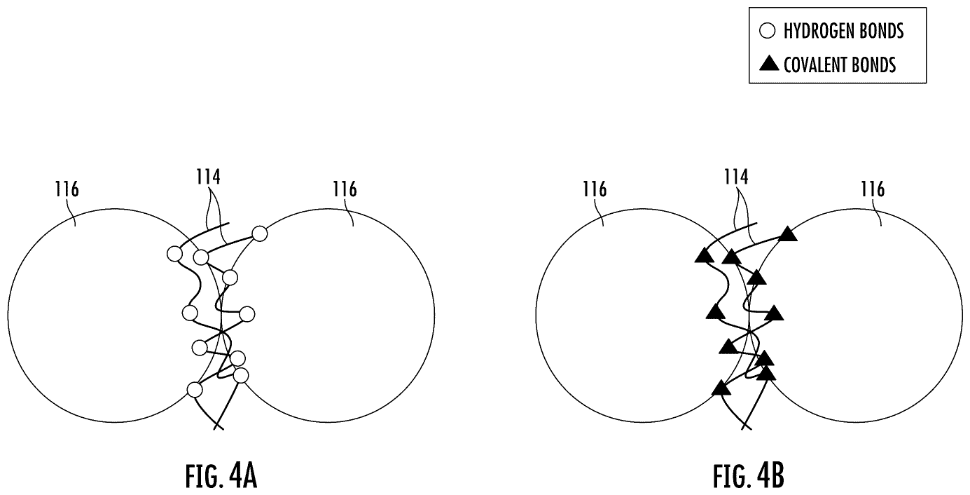

FIGS. 4A and 4B illustrate the difference between the bonds formed in green parts made via conventional binder jetting processes, and the strengthened green parts 106 formed using the chemical grafting agent 100 and methods contemplated herein. As shown, in the baseline case shown in FIG. 4A, hydrogen bonds occur between polyethylenimine (PEI) molecules 114 (i.e., the binder 104) and zeolite particles 116 (i.e., the powder 102) or, more specifically, their surface hydroxyl groups. These hydrogen bonds are not as strong as those formed using the chemical grafting method contemplated herein. As shown in FIG. 4B, a chemical grafting agent 100 is added to the binder 104 to react with PEI and the surface hydroxyl groups of the zeolite particles, forming covalent bonds between PEI molecules 114 and zeolite particles 116 (in lieu of hydrogen bonds).

The incorporation of a chemical grafting agent 100 into the binder jetting workflow, as described above, allows for tailoring of bond strength, geometry, and material compatibility. This significantly broadens the range of usable materials and eliminates the need for post-processing sintering in many cases. Functionality of the resulting parts is broadened, including improved mechanical integrity and compatibility with non-sinterable materials, while also reducing processing cost and complexity.

A person of ordinary skill in the art, having the benefit of this disclosure, will recognize that the presently described method can be extended to a wide variety of binder-powder-agent systems. The nature of the binder 104, powder 102, and chemical grafting agent 100 may be selected based on application-specific parameters such as target chemical functionality, porosity, sorption behavior, or mechanical robustness. As such, the presently disclosed systems and methods are adaptable to numerous functional materials and are not limited to the specific combinations described herein.

The present disclosure is related to a composition that may be produced using the method described above, or another method. The composition may comprise the binder 104, the powder 102, and the chemical grafting agent 100. In some embodiments, the binder 104 comprises a first sorbent and the powder 102 comprises a second sorbent. The chemical grafting agent 100 may comprise a silane moiety and may form covalent bonds between the binder 104 and the powder 102. In some embodiments, the covalent bonds may comprise urethane and/or urea linkages formed between the binder 104 and the powder 102. As noted above, the chemical grafting agent 100 may comprise 3-triethoxysilylpropyl isocyanate. The powder 102 may comprise surface hydroxyl groups selected from the group consisting of zeolites, metal oxides, and ceramic particles. In some embodiments, the binder 104 comprises a polyamine or a compound having multiple amine functional groups. The composition may be formed without thermal sintering above 150° C.

Many additional implementations, variations, and optimizations based on the disclosed principles are possible and will be apparent to one of ordinary skill in the art. Further implementations are within the CLAIMS.

It will be understood that implementations are not limited to the specific components disclosed herein, as virtually any components consistent with the intended operation of a method and/or system implementation for binder jetting of strong green parts using a chemical grafting agent may be utilized. Accordingly, for example, although particular binders, powders, and chemical grafting agents may be disclosed, such components may comprise any shape, size, style, type, model, version, class, grade, measurement, concentration, material, weight, quantity, and/or the like consistent with the intended operation of a method and/or system implementation for binder jetting of strong green parts using a chemical grafting agent.

In places where the description above refers to particular implementations of binder jetting of strong green parts using a chemical grafting agent, it should be readily apparent that a number of modifications may be made without departing from the spirit thereof and that these implementations may be applied to other additive fabrication processes. The presently disclosed methods and systems are, therefore, to be considered in all respects as illustrative and not restrictive.

I claim:

1. A method for fabricating a green part through binder jet fabrication, the method comprising:
preparing a binder and a powder for the binder jet fabrication;
printing the green part layer by layer by cyclically spreading a layer of powder and selectively jetting the binder through a printhead into the layer of powder;
curing a job box containing loose powder and the green part comprising the binder, the powder, and a chemical grafting agent; and
depowdering the green part by removing the green part from the loose powder.

2. The method of claim 1, wherein preparing the binder comprises mixing the chemical grafting agent with the binder.

3. The method of claim 2, wherein preparing the binder further comprises adding a NaOH solution to the binder and chemical grafting agent.

4. The method of claim 1, wherein the binder comprises polyethylenimine and the powder comprises Zeolite 13X.

5. The method of claim 1, wherein the chemical grafting agent comprises 3-triethoxysilylpropyl isocyanate.

6. The method of claim 1, wherein printing the green part further comprises introducing the chemical grafting agent to the green part in-situ, through the printhead.

7. The method of claim 1, wherein preparing the powder comprises mixing the chemical grafting agent with the powder.

8. The method of claim 1, wherein the powder comprises surface hydroxyl groups.

9. A method for fabricating a green part through binder jet fabrication, the method comprising:
preparing a binder comprising a first sorbent and a powder comprising a second sorbent for the binder jet fabrication;
printing the green part layer by layer by cyclically spreading a layer of powder and selectively jetting the binder through a printhead into the layer of powder;
curing a job box containing loose powder and the green part comprising the binder and the powder; and
depowdering the green part by removing the green part from the loose powder.

10. The method of claim 9, wherein preparing the binder comprises mixing a chemical grafting agent with the binder.

11. The method of claim 9, wherein the binder comprises polyethylenimine, the powder comprises Zeolite 13X, and the chemical grafting agent comprises 3-triethoxysilylpropyl isocyanate.

12. The method of claim 11, wherein preparing the binder further comprises adding a NaOH solution to the binder and chemical grafting agent.

13. The method of claim 9, wherein preparing the powder comprises mixing a chemical grafting agent with the powder.

14. The method of claim 9, wherein the green part comprises a chemical grafting agent.

15. A composition, comprising:
a binder comprising a first sorbent;
a powder comprising a second sorbent; and
a chemical grafting agent comprising a silane moiety, wherein the chemical grafting agent forms covalent bonds between the binder and the powder.

16. The composition of claim 15, wherein the chemical grafting agent comprises 3-triethoxysilylpropyl isocyanate.

17. The composition of claim 15, wherein the powder further comprises surface hydroxyl groups selected from the group consisting of zeolites, metal oxides, and ceramic particles.

18. The composition of claim 15, wherein the covalent bonds comprise urethane and urea linkages formed between the binder and the powder.

19. The composition of claim 15, wherein the binder comprises a polyamine or a compound having multiple amine functional groups.

20. The composition of claim 15, wherein the composition is formed without thermal sintering above 150° C.
